(19) United States
(12) Patent Application Publication
(10) Pub. No.: US 2010/0271332 A1
(43) Pub. Date: Oct. 28, 2010

(54) Optical input device, electronic device, and optical input system

(75) Inventors: Wen-Tai Wu, Taipei (TW); Tsung-Hsien Shen, Taipei (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei (TW)

(21) Appl. No.: 12/457,265

(22) Filed: Jun. 5, 2009

(30) Foreign Application Priority Data
Apr. 22, 2009 (TW) 098113394

(51) Int. Cl. G06F 3/042; H04N 5/225

(52) U.S. Cl. 345/175; 348/169; 348/E07.092

(57) ABSTRACT

An optical input device is applied in an electronic device. The optical input device includes a light source generator and a photosensitive plate. The light source generator has a body and a light source disposed within the body. The photosensitive plate is electrically connected to the electronic device, or is electrically disposed within the electronic device, and is electrically connected to a microprocessor. The light source of the light source generator emits a light ray through the body to form a light pattern image on the photosensitive plate. The photosensitive plate detects a deformation of the light pattern image, and outputs a control signal to the microprocessor correspondingly according to a shape of the light pattern image, enabling the electronic device to execute a corresponding preset function.

### CROSS-REFERENCE TO RELATED APPLICATIONS

This non-provisional application claims priority under 35 U.S.C. §119(a) on Patent Application No(s). 098113394 filed in Taiwan, R.O.C. on Apr. 22, 2009 the entire contents of which are hereby incorporated by reference.

### BACKGROUND OF THE INVENTION

1. Field of Invention

The present invention relates to an input device, an electronic device, and an input system, and more particularly to an optical input device, an electronic device having an optical input function, and an optical input system.

2. Related Art

A computer input device generally refers to a hardware device for inputting coordinate displacement signals to a computer device (for example a personal computer, a notebook computer or a personal digital assistant). Many types of computer input devices are available in the market, such as a mouse, a trackball device, a touchpad, a writing pad and a joystick. The mouse may input coordinate displacement signals to the computer device according to the user's movement. In addition, a scroll wheel is disposed on the mouse, which controls a vertical scrollbar or a horizontal scrollbar of a Windows interface. A microswitch is further disposed below the scroll wheel, and a user may give a confirmation instruction by pressing the scroll wheel. Therefore, in applications of the Windows system, the mouse becomes a most popular human-machine interface currently.

In addition to using a mouse for manipulation of a Windows interface of a computer device, a touchpad technology is also developed presently. The touchpad is installed on the computer device directly, such that the user controls sliding and clicking of a cursor directly on the touchpad with a finger to execute functions. Currently available touchpads are generally categorized into two types. One is a resistance type touchpad, and the other is a capacitance type touchpad. The actuation principle of the resistance type touchpad is to locate coordinate axes according to a voltage drop. When the finger of the user or an object touches the touchpad, a loop is conducted, and a voltage drop is generated, so as to calculate a coordinate position. The architecture of the capacitance type touchpad is a column/row interlacing sensing element matrix formed by one or more patterned indium tin oxide (ITO) layers. When the finger of the user or an object touches the touchpad, for an electric field of the ITO layer, a micro current loss is generated due to the touch of the finger or object, and a current coordinate position is calculated according to the micro current loss.

However, both the resistance type touchpad and the capacitance type touchpad are more difficult to design. As for wiring, a capacitance type touch panel at least needs 15 wires. When the requirements for sensing resolution are higher, the wiring becomes more and more complicated, causing a higher manufacturing difficulty. In addition, as sensing unit matrixes are disposed at a same layer of space, a touchable area of a sensing element matrix will be decreased, which makes the sensitivity lower. Further, the wirings in vicinity often lead to a problem of capacitance leakage. Especially, the temperature and humidity easily affects the correctness of sensing.

In addition, an optical sensing mode is also developed currently to control a computer device. An optical sensing window is disposed on the computer device. A microswitch is correspondingly disposed below the optical sensing window, such that the user gives confirmation instructions by pressing the optical sensing window. The optical sensing windows are categorized into two actuation types, namely, an image comparison type and an optical refraction comparison type. Although the user can control moving directions of a cursor or a scrolling direction of a scrollbar in a Windows interface through the optical sensing window, this type of optical sensing devices has the following problem: when the user performs system operation procedures such as a click operation or double click, the procedures still need to be accomplished by pressing the optical sensing window, or by pressing buttons on a mouse (for example, left button or right button), which is still complicated in operational actions.

For example, after a user controls a cursor in the Windows interface and moves the cursor to an object to be executed through the optical sensing window, the object is selected by pressing the optical sensing window or buttons again, so as to start a program function corresponding to the object. Thus, the convenience in operation still needs to be improved.

Although the convenience in operation of a computer device having an optical sensing window is improved sufficiently, as two optical sensing modules (one is for the optical sensing window, and the other is for controlling the mouse cursor) are used, the manufacturing cost of the computer device is increased, and the power consumption is also substantially increased relatively. In addition, the volume of the computer device must be increased to accommodate the two optical sensing modules.

Therefore, it is a problem for technical developers in related fields to provide an input processing method of a computer input device with improved convenience in operation.

### SUMMARY OF THE INVENTION

In view of the above, the present invention provides an optical input device, an electronic device, and an optical input system, thereby improving a touch or optical input device of a conventional electronic device, so as to solve the problem of inconvenience in use by a user caused by complicated operational actions.

The optical input device of the present invention is applied in an electronic device to enable the electronic device to execute a preset function. The optical input device includes a light source generator and a photosensitive plate. The light source generator has a body and a light source. The light source is disposed within the body, and emits a light ray through the body to form a light pattern image. The photosensitive plate is electrically connected to the electronic device, and the photosensitive plate has a microprocessor inside. The light pattern image generated by the light source generator is projected onto the photosensitive plate. The photosensitive plate detects a deformation of the light pattern image, and outputs a control signal to the microprocessor correspondingly according to a shape of the light pattern image. The control signal is transmitted to the electronic device through the microprocessor, enabling the electronic device to execute a corresponding preset function.

An electronic device of the present invention includes a body and a light source generator. The body has a microprocessor inside, and a photosensitive plate electrically connected to the microprocessor is disposed on a surface of the body. The light source generator has a body and a light source. The light source is disposed within the body, and emits a light ray through the body to form a light pattern image. The light pattern image generated by the light source generator is projected onto the photosensitive plate. The photosensitive plate detects a deformation of the light pattern image, and outputs a control signal to the microprocessor correspondingly according to a shape of the light pattern image, enabling the electronic device to execute a corresponding preset function.

The optical input device, the electronic device, and the optical input system of the present invention enable the electronic device to execute different preset functions correspondingly in a control mode of dynamic optical sensing, so as to provide a multi-functional input device to a user. Thus, the user can give control instructions to the electronic device rapidly and conveniently without pressing buttons additionally, thereby increasing operational convenience of the electronic device.

### BRIEF DESCRIPTION OF THE DRAWINGS

The present invention will become more fully understood from the detailed description given herein below for illustration only, and thus are not limitative of the present invention, and wherein:

FIG. 1 is a schematic three-dimensional view of an optical input device according to an embodiment of the present invention;

FIG. 2 is a schematic three-dimensional view of electrical connection between an optical input device and an electronic device according to an embodiment of the present invention;

FIGS. 3A to 3D are schematic views of actuation of an optical input device according to an embodiment of the present invention;

FIG. 4 is a schematic three-dimensional view of an optical input device having a lens according to an embodiment of the present invention;

FIG. 5 is a schematic three-dimensional view of an optical input device using a light-dependent resistor as a photosensitive plate according to an embodiment of the present invention;

FIG. 6 is a schematic three-dimensional view of an electronic device according to an embodiment of the present invention;

FIGS. 7A to 7D are schematic views of actuation of an electronic device according to an embodiment of the present invention;

FIG. 8 is a schematic three-dimensional view of an electronic device having a lens according to an embodiment of the present invention;

FIG. 9 is a schematic three-dimensional view of an electronic device using a light-dependent resistor as a photosensitive plate according to an embodiment of the present invention;

FIG. 10 is a schematic three-dimensional view of an electronic device according to another embodiment of the present invention; and

FIG. 11 is a schematic three-dimensional view of an optical input system according to another embodiment of the present invention.

### DETAILED DESCRIPTION OF THE INVENTION

An optical input device of the present invention is applied to an electronic device. The electronic device includes (but is not limited to) portable electronic devices such as a smart mobile phone (a personal digital assistant (PDA) phone, a smart phone), a portable navigation device (PND), a portable media player (PMP), a mobile TV, a PDA, or an ultra mobile PC (UMPC). In the following detailed illustration of the present invention, a laptop computer is taken as a most preferred embodiment of the present invention. However, the drawings are only illustrative and for reference, but are not intended to limit the present invention.

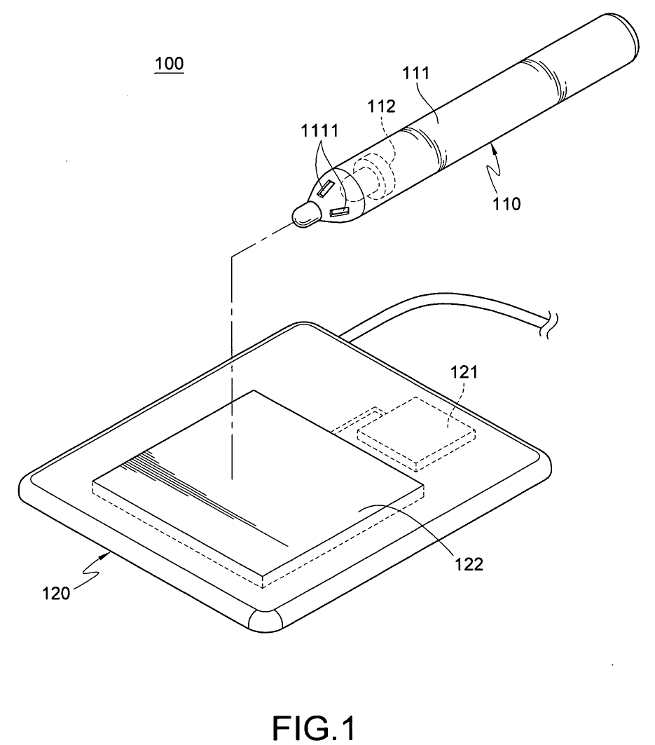

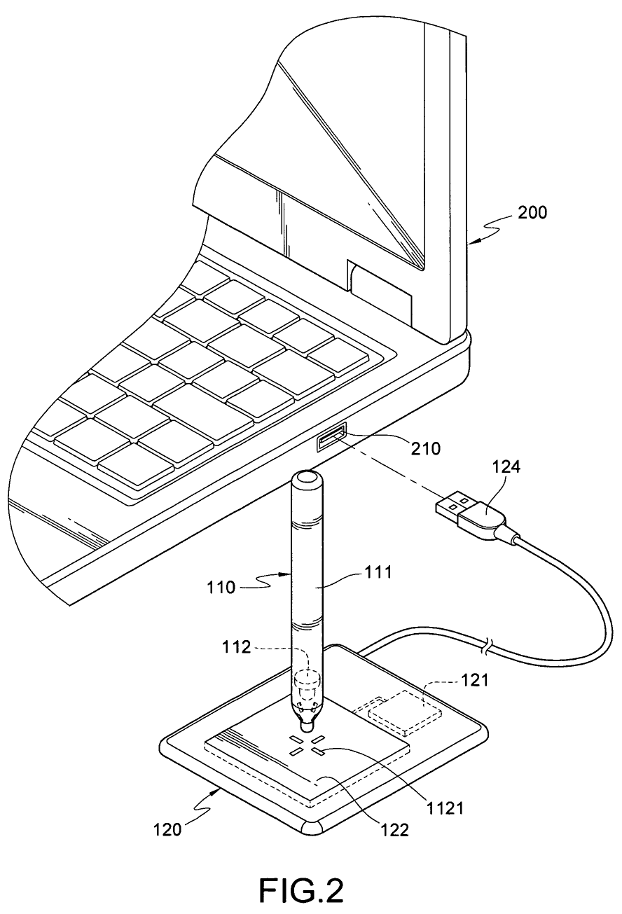

FIGS. 1 and 2 are schematic views of an optical input device and an electronic device using the optical input device of the present invention respectively. An optical input device 100 of the present invention is applied in an electronic device 200, and the electronic device 200 may execute at least one preset function, for example, execute functions including, but limited to, starting a video and audio playback program, controlling window displacement, opening e-mails, and opening a browser.

The optical input device 100 includes a light source generator 110 and a photosensitive plate 120. The light source generator 110 of the present invention may be applied in a stylus or a touch pen, and the light source generator 110 has a body 111 and at least one light source 112. The body 111 has an accommodating space inside. A through hole 1111 is provided on one end surface of the body 111. The light source 112 is disposed within the body 111, and faces the through hole 1111. The light source 112 emits a light ray through the through hole 1111 of the body 111 to form a light pattern image 1121. A shape of the light pattern image 1121 is corresponding to a shape of the through hole 1111. The shape of the through hole 1111 in the present invention is a cross, such that the formed light pattern image 1121 is a cross pattern formed by four long rectangular patterns. However, those skilled in the art may also design the through hole 1111 of the body 111 as any geometric shape, which is not limited to this embodiment. Alternatively, a lens (not shown) or a light shield may be added onto the through hole 1111, so as to generate a different light pattern image 1121 according to principles of light refraction or light shielding. In addition, the light source 112 of the present invention may be a light emitting element such as a light emitting diode (LED) or a laser diode, so as to emit a light ray having a directional characteristic. The light source 112 is not limited to the embodiments disclosed in the present invention.

The photosensitive plate 120 has a microprocessor 121 inside, and the photosensitive plate 120 has a universal serial bus (USB) connector 124 electrically connected to the microprocessor 121. A USB port 210 is disposed on one side of the electronic device 200, and the USB connector 124 is electrically inserted in the USB port 210, such that electrical connection is established between the photosensitive plate 120 and the electronic device 200. For the optical input device 100 and the electronic device 200 of the present invention, in addition to electrical connection through wired USB interfaces, wireless transmission may also be employed to transfer signals. For example, the wireless transmission is infrared transmission or Bluetooth transmission. The control signal transmission is not limited to the wired transmission disclosed in this embodiment.

A light sensor 122 is disposed on a surface (that is, an upper surface) of the photosensitive plate 120, so as to form a light sensitive area on the surface of the photosensitive plate 120. It should be noted that the light sensor 122 of the present invention may be, but is not limited to, a charge-coupled device (CCD) or a complementary metal-oxide semiconductor (CMOS).

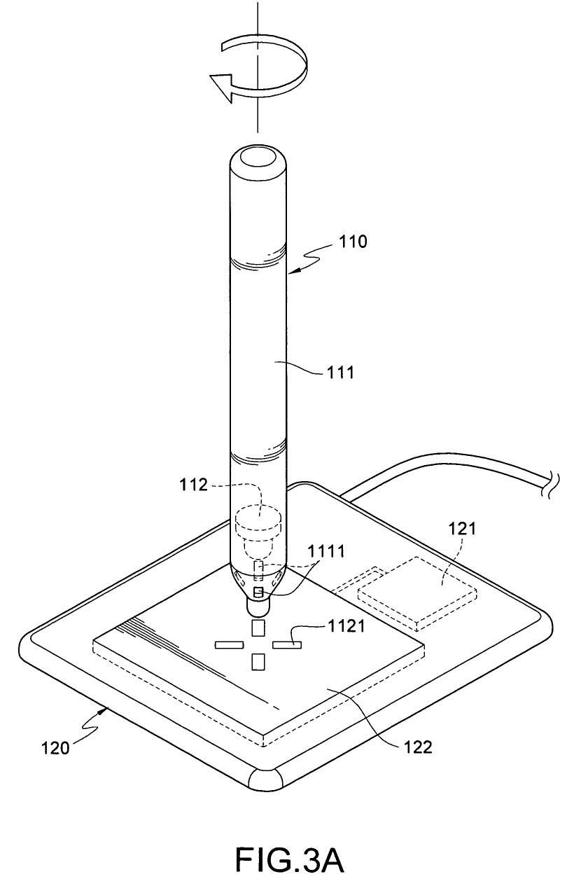

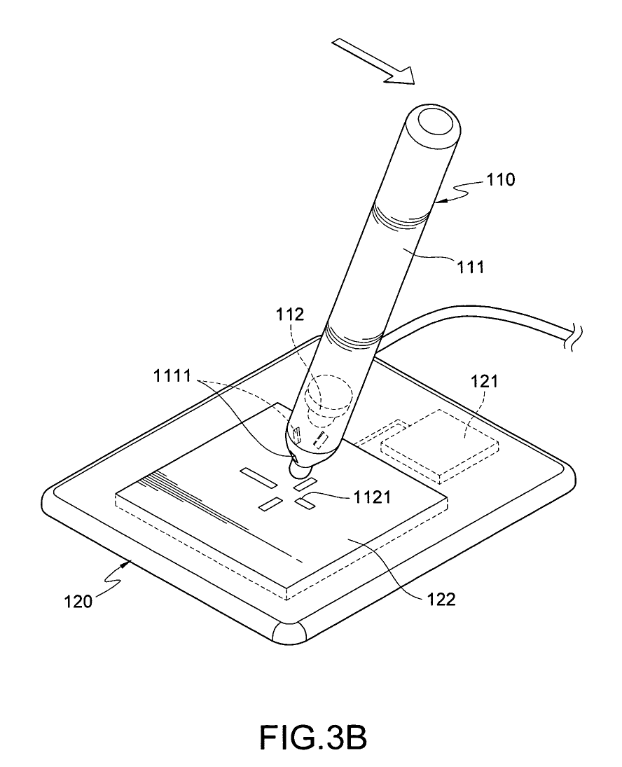

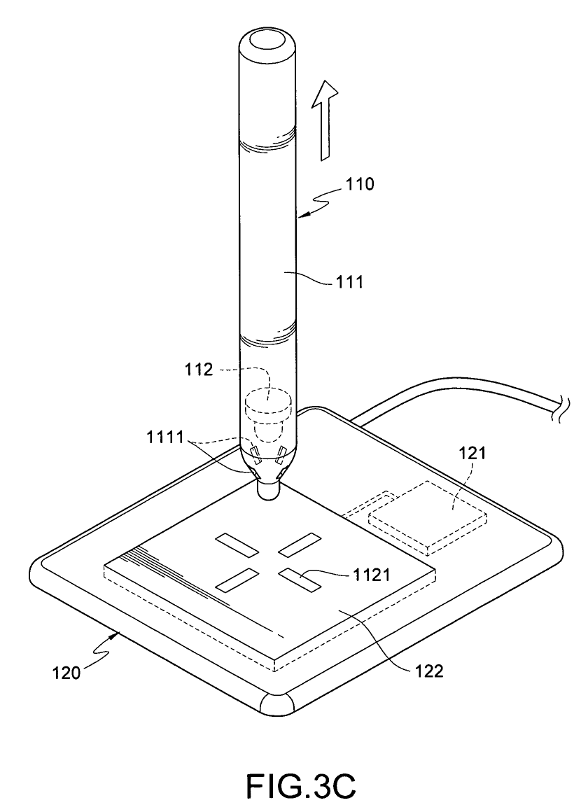

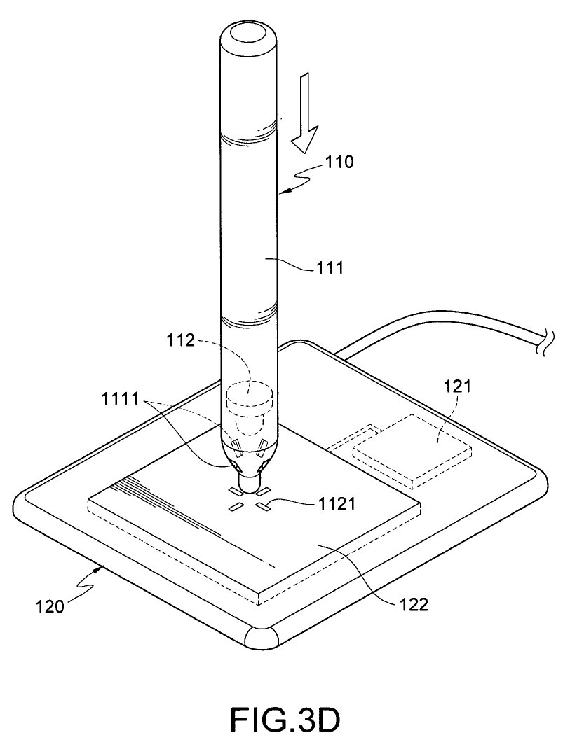

Referring to FIG. 2 and the schematic views of actuation of FIGS. 3A to 3D, the light pattern image 1121 generated by the light source generator 110 of the present invention is projected onto the photosensitive plate 120. As shown in FIG. 3A, when the light source generator 110 rotates relative to the photosensitive plate 120, the light pattern image 1121 generated by the light source generator 110 rotates an angle from an originally forward symmetrical cross pattern. Alternatively, as shown in FIG. 3B, when the light source generator 110 inclines by an angle relative to the photosensitive plate 120, the light pattern image 1121 generated by the light source generator 110 extends from one end of the originally symmetrical cross pattern to become an asymmetrical cross pattern. Alternatively, as shown in FIG. 3C, when the light source generator 110 displaces upward relative to the photosensitive plate 120, the light pattern image 1121 generated by the light source generator 110 is enlarged proportionally from the original size. Alternatively, as shown in FIG. 3D, when the light source generator 110 displaces downward relative to the photosensitive plate 120, the light pattern image 1121 generate by the light source generator 110 shrinks from the original size proportionally. In addition, a light shield may be used to change a pattern of the light pattern image 1121. Alternatively, one end having the through hole 1111 of the body 111 of the light source generator 110 is designed as a detachable structure, such that the body may use a through hole 1111 of a different shape at any time, so as to change the light pattern image 1121.

At this time, the light sensor 122 detects a deformation of the light pattern image 1121 consecutively, and outputs a control signal to the microprocessor 121 for signal processing correspondingly according to a shape of the light pattern image 1121 (such as various shapes of the light pattern image 1121 shown in FIGS. 3A to 3D). Next, the microprocessor 121 electrically transmits the control signal into the electronic device 200 through the USB interface, and then the control signal is processed by a circuit system (not shown) of the electronic device 200, enabling the electronic device 200 to execute a preset function (for example, functions such as starting a video and audio playback program, controlling window displacement, opening e-mails, opening a browser, and moving objects in a program) corresponding to the control signal.

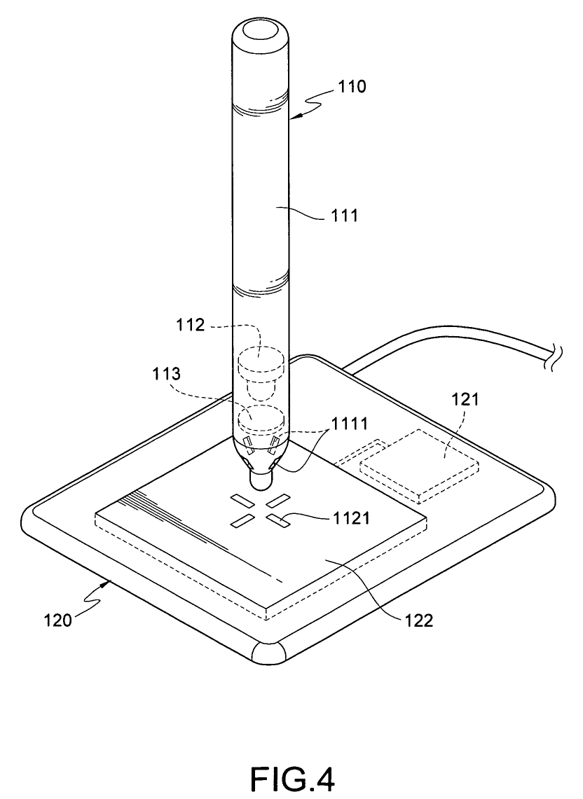

Referring to FIG. 4, the light source generator 110 of the optical input device 100 of the present invention further includes a lens 113, which is disposed inside the body 111 of the light source generator 110, and is located between the light source 112 and the through hole 1111, so as to refract a light ray emitted by the light source 112 through the through hole 1111. With focusing of the lens 11, a light intensity of the light source 112 of the present invention is increased. The lens 113 disclosed in the present invention may be various types of lenses such as a biconvex lens, a biconcave lens, or a meniscus lens; however, those skilled in the art may choose a lens with optimal optical characteristics according to actual requirements.

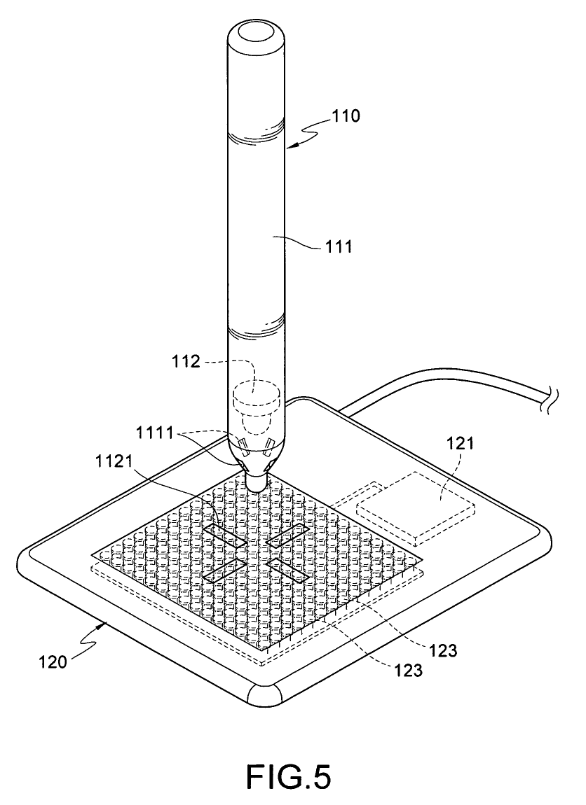

As shown in FIG. 5, for the photosensitive plate 120 disclosed in the present invention, in addition to using the light sensor 122 shown in FIG. 1 as a sensing element for sensing a light ray, a plurality of light-dependent resistors 123 arranged in a light sensitive area may also be used. The plurality of light-dependent resistors 123 is electrically connected to the microprocessor 121 inside the photosensitive plate 120, so as to dynamically capture shape changes of the light pattern image. That is, when the light source generator 110 projects the light pattern image 1121 on a light sensitive area of the photosensitive plate 120, resistance of the light-dependent resistors 123 for sensing the light intensity reduces, thereby generating a control signal and outputting it to the microprocessor 121. The control signal is transmitted to the electronic device 200 by the microprocessor 121, enabling the electronic device 200 to execute a preset function corresponding to the control signal.

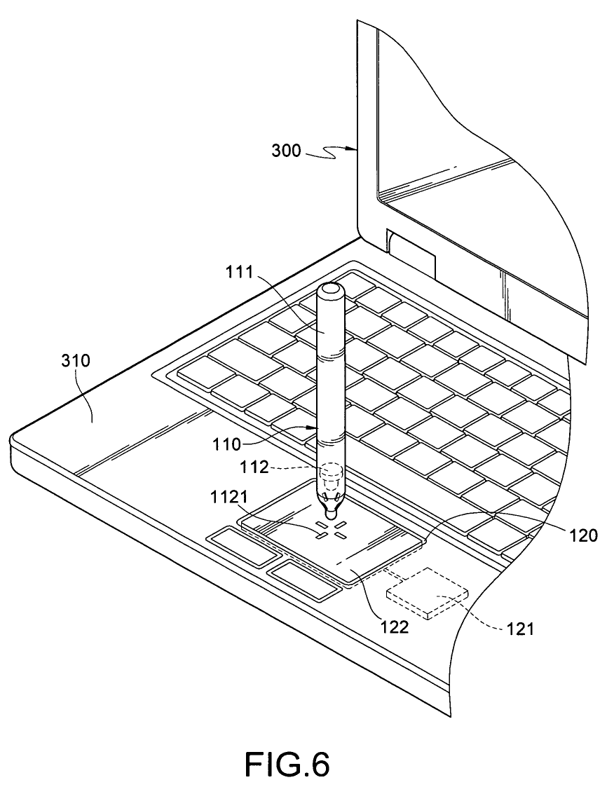

In a schematic view of FIG. 6, an electronic device 300 of the present invention includes a body 310 and at least one light source generator 110. The body 310 has a microprocessor 121 and a circuit system (not shown) inside, so as to control the electronic device 300 to execute a preset function (for example, functions such as starting a video and audio playback program, controlling window displacement, opening e-mails, and opening a browser). A photosensitive plate 120 is disposed on a surface of the body 310 (that is, an upper surface). A light sensor 122 is disposed on the photosensitive plate 120, and a light sensitive area is formed on a surface of the photosensitive plate 120. The light sensor 122 is electrically connected to the microprocessor 121. It should be noted that the light sensor 122 of the present invention may be, but is not limited to, a CCD or a CMOS.

The light source generator 110 of the present invention may be applied in a stylus or a touch pen, and the light source generator 110 has a body 111 and a light source 112. The body 111 has an accommodating space inside. A through hole 1111 is provided on one end surface of the body 111. The light source 112 is disposed within the body 111, and faces the through hole 1111. The light source 112 emits a light ray through the through hole 1111 of the body 111 to form a light pattern image 1121. A shape of the light pattern image 1121 is corresponding to a shape of the through hole 1111. Those skilled in the art may also design the through hole 1111 of the body 111 into any geometric shape. A lens or a light shield may also be used to change a pattern of the light pattern image 1121. The geometric shape is not limited to this embodiment. In addition, the light source 112 of the present invention may be a light emitting element such as an LED or a laser diode, so as to emit a light ray having a directional characteristic.

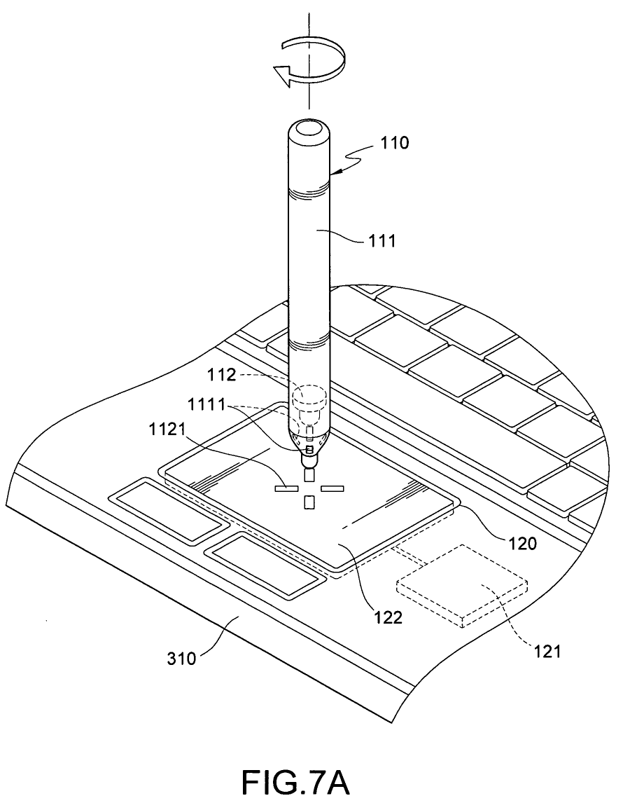

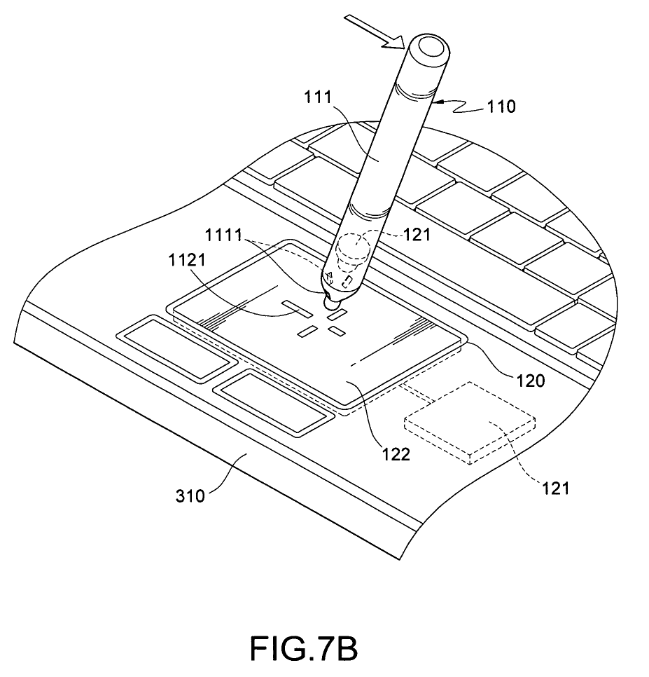

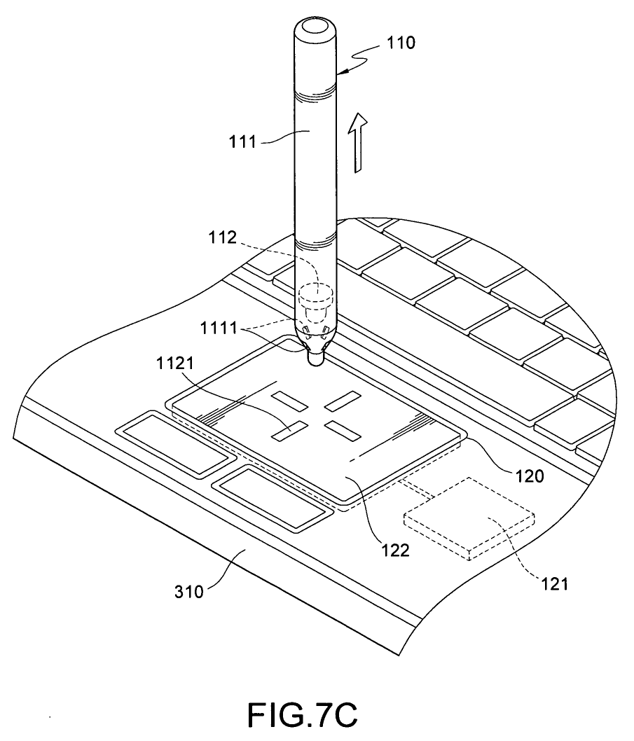

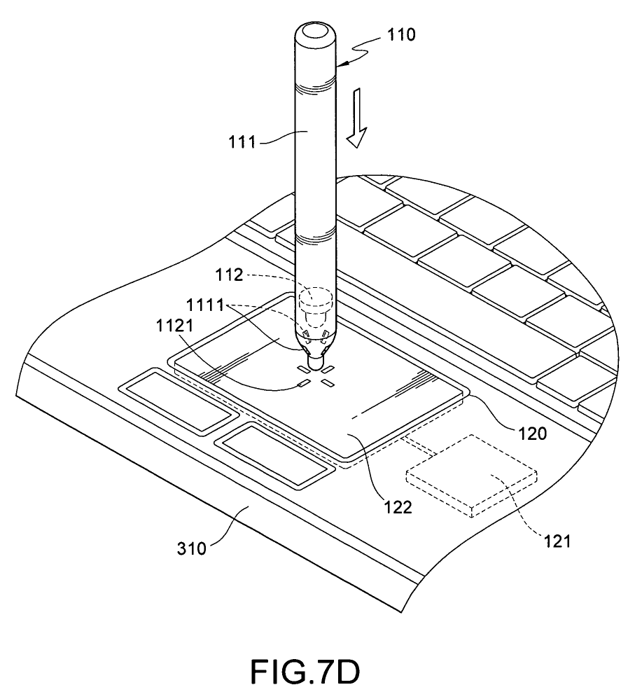

Referring to FIG. 6 and schematic views of actuation of FIGS. 7A to 7D, the light pattern image 1121 generated by the light source generator 110 of the present invention is projected onto the photosensitive plate 120. When the light source generator 110 is subject to actuations such as rotation, inclination by an angle, upward displacement, or downward displacement relative to the photosensitive plate 120, the light pattern image 1121 generated by the light source generator 110 is changed correspondingly from an original shape and size. At this time, the light sensor 122 continuously detects a deformation of the light pattern image 1121, and outputs a control signal to the microprocessor 121 correspondingly according to the shape of the light pattern image 1121, enabling the electronic device 200 to execute a preset function corresponding to the control signal. In addition, a light shield may also be used to change a pattern of the light pattern image 1121. Alternatively, one end having a through hole 1111 of the body 111 of the light source generator 110 is designed as a detachable structure, such that the body may use a through hole 1111 of a different shape at any moment, so as to change the light pattern image 1121.

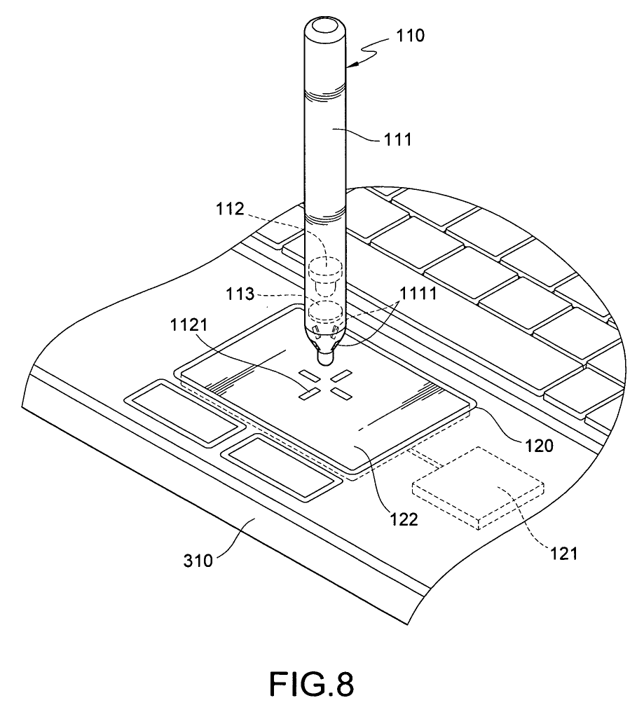

Referring to FIG. 8, the light source generator 110 of the electronic device 300 of the present invention further includes a lens 113, which is disposed inside the body 111 of the light source generator 110, and is located between the light source 112 and the through hole 1111, so as to refract a light ray emitted by the light source 112 through the through hole 1111. With focusing of the lens 113, a light intensity of the light source 112 of the present invention is increased. The lens 113 disclosed in the present invention may be various types of lenses such as a biconvex lens, a biconcave lens, or a meniscus lens; however, those skilled in the art may choose a lens with optimal optical characteristics according to actual requirements.

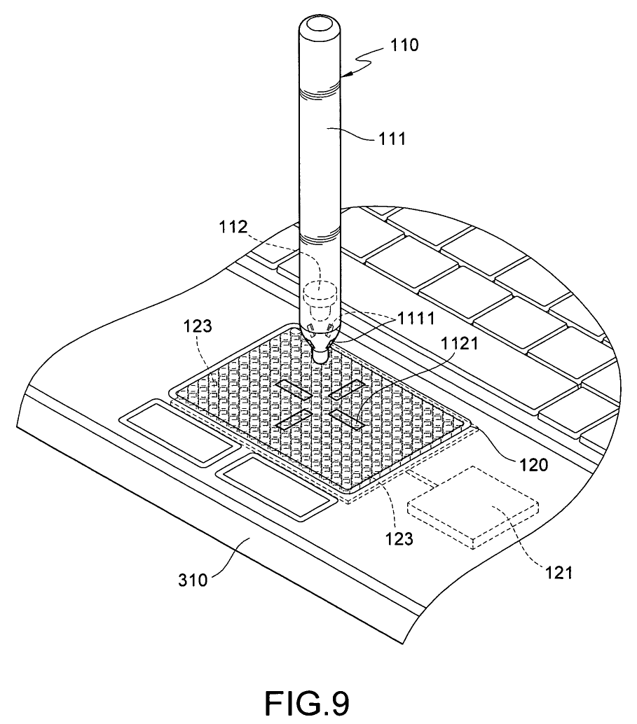

As shown in FIG. 9, for the photosensitive plate 120 of the present invention, in addition using the light sensor 122 shown in FIG. 6 as a sensing element to sense the light ray, a plurality of light-dependent resistors 123 arranged in a light sensitive area may also be used. The plurality of light-dependent resistors 123 is electrically connected to the microprocessor 121 inside the body 310 respectively, so as to dynamically capture shape changes of the light pattern image. That is, when the light source generator 110 projects the light pattern image 1121 on the light sensitive area of the photosensitive plate 120, resistance of the light-dependent resistors 123 for sensing the light intensity reduces, thereby generating a control signal and outputting it to the microprocessor 121. The control signal is transmitted to the electronic device 300 by the microprocessor 121, enabling the electronic device 300 to execute a preset function corresponding to the control signal.

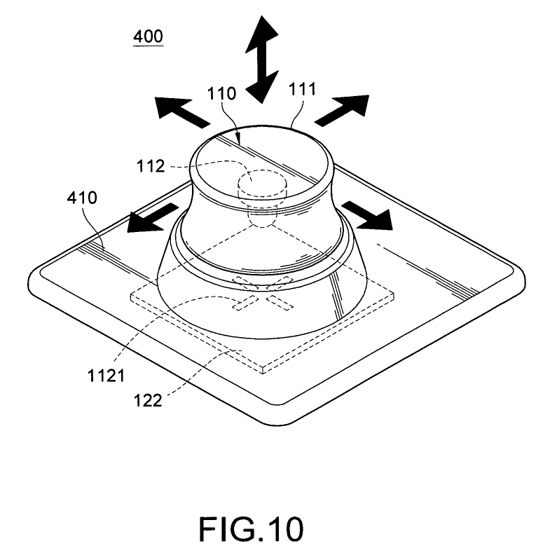

FIG. 10 is a schematic view of an electronic device according to another embodiment of the present invention. The electronic device 400 in this embodiment is a platform computer input device similar to a digitizing tablet, which includes a body 410 and a light source generator 110. The body 410 has a circuit system (not shown) and a light sensor 122 electrically connected to the circuit system inside. The light sensor 122 of the present invention may be, but is not limited to, a CCD or a CMOS.

An opening is disposed on a top surface of the body 410, and the light source generator 110 is installed in the opening and constantly accommodated on the body 410 without falling off. The light source generator 110 may moveably displace at a same position relative to the body 410. A light source 112 is disposed inside the body 111 of the light source generator 110, and faces the light sensor 122. The light source 112 may emit a light ray through the body 111 and forms a light pattern image 1121 on the light sensor 122. The light source 112 of the present invention may be a light emitting element such as an LED or a laser diode, so as to emit a light ray with a directional characteristic. The light source 112 is not limited to the embodiments disclosed in the present invention.

When the light source generator 110 is subject to actuations such as rotation, inclination by an angle, upward displacement, or downward displacement relative to the body 410, the light pattern image 1121 generated by the light source generator 110 changes from an original shape and size correspondingly. At this time, the light sensor 122 captures detects a deformation of the light pattern image 1121 continuously, and outputs a control signal to the circuit system correspondingly according to a shape of the light pattern image 1121, enabling the electronic device 400 to transmit the control signal to a computer device (not shown) in a wired or wireless mode.

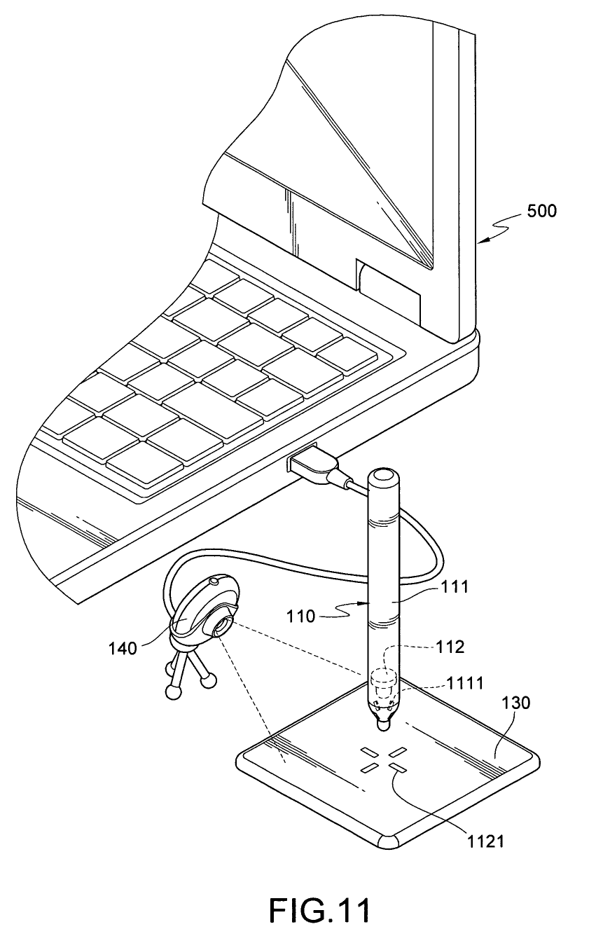

As shown in FIG. 11, another optical input system is disclosed in the present invention. The optical input system includes a light source generator 110, a work plane 130, and a light pattern image capturing device 140. The light source generator 110 of the present invention may be applied in a stylus or a touch pen, and the light source generator 110 has a body 111 and a light source 112. The body 111 has an accommodating space inside. A through hole 1111 is provided on one end surface of the body 111. The light source 112 is disposed within the body 111, and faces the through hole 1111. The light source 112 emits a light ray through the through hole 1111 of the body 111 to form a light pattern image 1121. A shape of the light pattern image 1121 is corresponding to a shape of the through hole 1111. Those skilled in the art may also design the through hole 1111 of the body 111 into any geometric shape. Alternatively, a lens or a light shield may also be used to change a pattern of the light pattern image 1121. The geometric shape is not limited to this embodiment. In addition, the light source 112 of the present invention may be a light emitting element such as an LED or a laser diode, so as to emit a light ray with a directional characteristic.

The light pattern image capturing device 140 of the present invention is electrically connected to an electronic device 500, and faces a direction of the work plane 130 to capture an image on the work plane 130. The light pattern image capturing device 140 of the present invention is a webcam, but is not limited thereto. Any image capturing device may be chosen as the light pattern image capturing device 140 of the present invention. The light pattern image 1121 generated by the light source generator 110 is projected on the work plane 130. The work plane 130 of the present invention is a flat pad, and a desk surface may also serve as the work plane 130 of the present invention directly. When the light source generator 110 is subject to actuations such as rotation, inclination by an angle, upward displacement, or downward displacement relative to the work plane 130, the light pattern image 1121 generated by the light source generator 110 changes correspondingly from an original shape and size. At this time, the light pattern image capturing device 140 detects a deformation of the light pattern image 1121 projected on the work plane 130 continuously, and outputs a control signal to the electronic device 500 correspondingly according to a shape of the light pattern image 1121, enabling the electronic device 500 to execute a preset function corresponding to the control signal.

The optical input device and the electronic device of the present invention provide a signal input means different from the prior art. The electronic device is controlled to execute a corresponding preset function in an optical sensing mode that a photosensitive plate detects a deformation of the light pattern image, so it is unnecessary to press the buttons additionally. Thus, a user can give different control commands to the electronic device rapidly and conveniently, thereby increasing the convenience in use.

What is claimed is:

1. An optical input device, applied in an electronic device, comprising:
a light source generator, having a body and at least one light source, wherein the light source is disposed within the body, and emits a light ray through the body to form a light pattern image; and
a photosensitive plate, electrically connected to the electronic device, and having a microprocessor inside;
wherein the light pattern image generated by the light source generator is projected onto the photosensitive plate, the photosensitive plate detects a deformation of the light pattern image and outputs a control signal to the microprocessor correspondingly, and the microprocessor transmits the control signal to the electronic device.

2. The optical input device according to claim 1, wherein the light source generator further comprises a lens disposed within the body for refracting the light ray through the body.

3. The optical input device according to claim 1, wherein a light sensor is disposed on the photosensitive plate, the light sensor is electrically connected to the microprocessor, and is adapted to dynamically capture shape changes of the light pattern image and to output the control signal to the microprocessor correspondingly.

4. The optical input device according to claim 1, wherein the photosensitive plate comprises a plurality of light-dependent resistors electrically connected to the microprocessor, and the light-dependent resistors are adapted to dynamically capture shape changes of the light pattern image and to output the control signal to the microprocessor correspondingly.

5. An electronic device, comprising:
a body, having a microprocessor inside and a photosensitive plate on a surface of the body, wherein the photosensitive plate is electrically connected to the microprocessor; and
a light source generator, having a body and at least one light source, wherein the light source is disposed within the body, and emits a light ray through the body to form a light pattern image;
wherein the light pattern image generated by the light source generator is projected onto the photosensitive plate, the photosensitive plate detects a deformation of the light pattern image and outputs a control signal to the microprocessor correspondingly, and the electronic device executes a corresponding preset function.

6. The electronic device according to claim 5, wherein the light source generator further comprises a lens disposed within the body for refracting the light ray through the body.

7. The electronic device according to claim 5, wherein a light sensor is disposed on the photosensitive plate, the light sensor is electrically connected to the microprocessor, and is adapted to dynamically capture shape changes of the light pattern image and to output the control signal to the microprocessor correspondingly.

8. The electronic device according to claim 5, wherein the photosensitive plate comprises a plurality of light-dependent resistors electrically connected to the microprocessor, and the light-dependent resistors are adapted to dynamically capture shape changes of the light pattern image and to output the control signal to the microprocessor correspondingly.

9. An optical input system, applied in an electronic device, comprising:
a light source generator, having a body and at least one light source, wherein the light source is disposed within the body, and emits a light ray through the body to form a light pattern image;
a light pattern image capturing device, connected to the electronic device; and
a work plane;
wherein the light pattern image generated by the light source generator is projected on the work plane, the image capturing device detects a deformation of the light pattern image, and a corresponding control signal is generated within the electronic device.

10. The optical input system according to claim 9, wherein the light pattern image capturing device is a webcam.
